(19) United States
(12) Patent Application Publication
(10) Pub. No.: US 2013/0105019 A1
(43) Pub. Date: May 2, 2013

(54) VALVE CARTRIDGE FOR A SANITARY FITTING

(71) Applicant: HANSGROHE SE, Schiltach (DE)

(72) Inventors: Juergen Gross, Muehlenbach (DE); Juergen King, Lauterbach (DE)

(73) Assignee: HANSGROHE SE, Schiltach (DE)

(21) Appl. No.: 13/652,579

(22) Filed: Oct. 16, 2012

(30) Foreign Application Priority Data
Oct. 20, 2011 (DE) 102011084837.1

(51) Int. Cl. B01F 3/08

(52) U.S. Cl. CPC B01F 3/08
USPC 137/896

(57) ABSTRACT

A valve cartridge for a sanitary fitting includes a cartridge housing with a disk control operated by a rotatable operating element. By turning the operating element, the disk control initially opens the water duct for cold water, starting from a closed position of the valve. When the operating element is turned further, the water passage for hot water is opened and, to the same extent the water duct for cold water is closed. In an end position, only the passage for hot water is open. A removable stop element can interact with a transverse bolt of the operating element to limit the adjustable range on one end so that the disk control cannot fully close, but can only be adjusted between the maximum opening position for cold water and the maximum opening position for hot water.

The invention is based on a valve cartridge for a sanitary fitting.

Sanitary fittings including valve cartridges, where by operating an operating element from a first position initially the passage for cold water is gradually opened and, upon further movement of the operating element in the same direction, subsequently the passage for cold water is closed and the passage for hot water is opened, so that during said movement the mixing ratio between cold and hot water continuously changes from cold to hot, have been well-known for a long time. Finally, at the end of the movement, exclusively the passage for hot water is opened. Valve cartridges of said kind are advantageous in that upon opening the valve, an initial flow of cold water is ensured.

Valves of such type serve both to open and close the sanitary fitting as well as to adjust the mixing ratio and thus the temperature of the water flowing out.

Rotary cartridges that do not have a closed position and only serve to adjust the mixing ratio, are also well-known from the prior art.

The ways and means of adjustment of the opening cross-sections within the cartridge can be of variable design. There are mixer devices including stroke pistons or rotary pistons, each to control one water feed line but connected to one another by a common operating element, for example.

However, most-widespread in use are the so-called disk controls, wherein a fixed so-called distributor disk made of ceramics includes the inlet openings and, where applicable the outlet opening for the mixed water, while a movable control disk having openings therein brings the inlet openings into different cover positions so that the cross-sections are varied respectively. The mixed water can either get to the outlet of the valve cartridge through the movable control disk, or can be deflected within the movable control disk and get through an outlet opening of the distributor disk.

Also known are such controls, particularly disk controls, by means of which only the temperature is controlled by changing the mixing ratio between hot and cold water, while a second valve serves to control the quantity of discharged mixed water.

Both types of controls can be realized in valve cartridges by replacing the control disks with different control disks that have openings with correspondingly different shapes.

In the case of a known safety mixer for low pressure accumulators, a disk control is used, and operated by the rotating the movable control disk by means of a rotary handle (DE 2912909 A1).

The object underlying this invention is to provide a more versatile mixer cartridge for a sanitary fitting.

The object is achieved by a mixer cartridge according to the features named in claim 1. Advancements of the invention are subject-matter of dependant claims.

Thus, the mixer cartridge proposed by the invention includes a disk control which can be operated by means of an operating element. By means of the operating element, the disk control can be opened from a closed position, where water does not pass through the water outlet of the cartridge, and in doing so, initially only the passage for cold water is opened. Said transition is a more or less continuous process. When the operating element is further moved in the same direction, in addition to the passage for cold water the passage for hot water is opened as well, and at the same time, the passage for cold water is closed again. The passage for hot water is opened to the same extent as the passage for cold water is closed again. At the end of the transition area, only the passage for the hot water is completely opened.

In the case of disk controls, the movement of the operating element is usually a rotation. Both end positions are determined by the fact that the operating element abuts a respective stop fixed to the housing.

Where the additional stop element according to the invention is not fixed to the cartridge housing, the mixer cartridge is to be operated in a manner as described above, namely to turn the water on or to change the temperature.

However, by means of the attachment facility, there is now a possibility to attach the removable stop element, in order to thus limit the movability of the operating element and along with that the adjustability of the mixer cartridge. This is effected without an intervention inside the cartridge, that is to say without change or replacement of the disks of the disk control. Thus, the created mixer cartridge may be used in different ways or obtain another characteristic through a simple intervention from the outside without need to open the cartridge housing.

In particular, the attachment facility for the removable stop element can be embodied in such a way that the latter limits movement of the operating element in the direction of the closed position. In an advanced configuration, the limitation can be embodied in such a way that the closed position of the disk control cannot be reached by means of the operating element. In this case, the mixer cartridge is a pure temperature control.

However, it is also possible and proposed by the invention that the attachment facility is embodied in such a way that the removable stop element limits the movement of the operating element in the direction of the opened position for hot water. In this case, both a partial and a complete blocking of the position of the disk control, where the opening for cold water is connected to the outlet of the valve cartridge, can be provided.

In the case of an only partial limitation of said end position of the travel path of the operating element, some kind of temperature limit or economy position can be realized, where the amount of hot water and thus the amount of energy required to generate this hot water is limited.

It can particularly be provided that the removable stop element can be attached in several angular positions on both the one side and the other side of the travel path of the operating element in order to also realize, for example, the partial or complete blocking of an end position.

A particularly significant type of attachment of the stop element preferred by the invention may consist in that the stop element is plugged onto the housing of the valve cartridge, in particular in axial direction. This can in some cases also be effected without removal of the valve cartridge from the sanitary fitting.

The operating element of such a valve cartridge is usually a shaft projecting out of the upper side of the valve cartridge. In order to limit the rotary movement, said shaft can have a transverse element, in particular a transverse bolt, interacting with the stops fixed to the housing and also with the removable stop element.

According to the invention can be provided that at least one stop element, particularly the removable stop element, is adapted to the cross-sectional shape of the transverse bolt, in order to allow improved absorption of the forces involved.

In yet another advancement can be provided that the cartridge housing has a housing upper part with a cover face, which is only partially developed, having the shape of a circle sector, for example. The radially running end portions can thereby establish the stop fixed to the housing and present on both sides.

In yet another advancement of the invention can be provided that the lateral surface area of the housing upper part features a toothing which is embodied to fix the removable stop element.

Further features, details and advantages of the invention arise from the claims and the summary, while the wording of both is incorporated into the content of the description by reference, and the following description of preferred embodiments of the invention as well as the drawing. The drawing shows in:

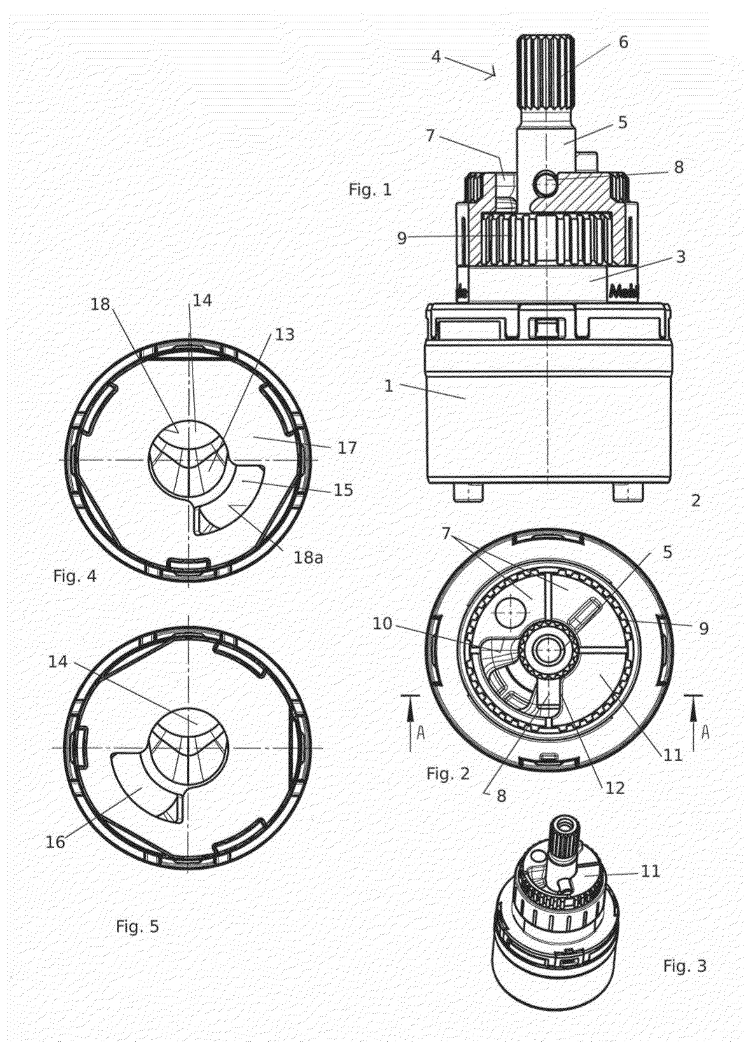

FIG. 1 a partial cross- sectional side view of a mixer cartridge according to the invention;

FIG. 2 a plan view of the mixer cartridge according to FIG. 1;

FIG. 3 a perspective view of the valve cartridge;

FIG. 4 the plan view of the disk control in the cold water position;

FIG. 5 the plan view of the disk control in the hot water position;

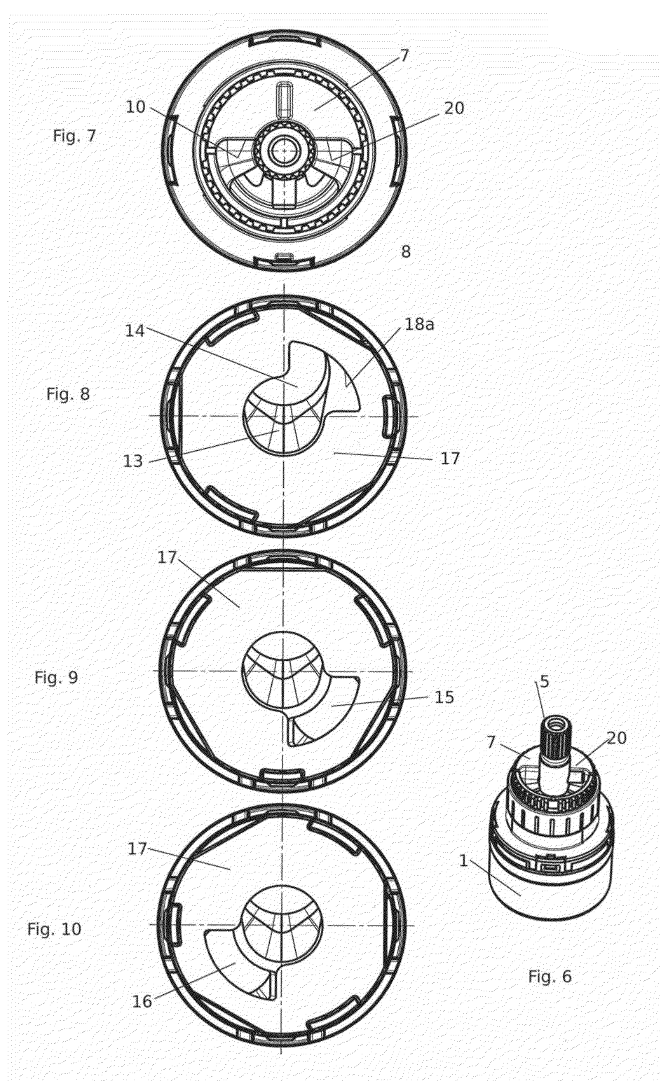

FIG. 6 the perspective view of the valve cartridge without the additional stop;

FIG. 7 an illustration according to FIG. 2 of the valve cartridge of FIG. 6;

FIG. 8 the plan view of the disk control in completely closed position;

FIG. 9 the plan view of the disk control in the cold water position for the embodiment according to FIG. 6;

FIG. 10 the plan view of the disk control in the hot water position for the embodiment according to FIG. 6.

FIG. 1 shows a partial cross-sectional side view of the valve cartridge according to the invention. The valve cartridge includes a cartridge housing 1 essentially in a cyclindrical design. A bottom part 2 of the cartridge housing 1 is used for connection to water ducts in the sanitary fitting. A housing upper part 3 projects from the cylindrical part of the cartridge housing 1, with the diameter of the housing upper part 3 being smaller than the cylindrical part of the cartridge housing 1. The disk control, which is arranged in the cartridge housing 1, is operated with an operating element 4, in the form of a shaft 5 adapted to rotating around an axis. In order to ensure a co-rotational connection to the rotary handle, the upper end of the shaft 5 is provided with a longitudinal toothing 6.

A transverse bolt 8 with a circular cross-section is inserted in the shaft 5 approximately at the height of the upper face wall 7 of the housing upper part 3. In FIG. 1, the transverse bolt 8 runs perpendicular to the drawing plane.

A housing upper part 3 has a longitudinal toothing 9, partially extending in axial direction starting from the upper face wall 7, and partially illustrated in the side view of FIG. 1. Said longitudinal toothing 9 can also be seen in FIG. 2 which is a plan view of the valve cartridge of FIG. 1. Here, the above-mentioned upper face wall 7 extending over approximately half of the upper part of the housing upper part 3, is also visible. It forms a nearly radially running edge 10. In FIG. 2, the second edge on the diametrically opposing side is covered by a stop element 11, which, for its part, has a radially running edge 12. Said edge 12 is located at the height of the transverse bolt 8 and thus forms a stop for said transverse bolt 8.

As can be seen from FIG. 2, the operating element 4, namely the shaft 5, can be rotated in an area bounded by the edges 10 and 12. Said edges form stop edges in order to limit the rotational movement of the operating element, while rotation thereof is transferred to rotation of the control disk of the disk control. The two edges 10 and 12 run slightly laterally opposite to a radial line running through the center point and accordingly the rotation axis of the operating element 4, so that when the transverse bolt is in contact with the respective edge 10 or 12, the axis of the transverse bolt follows said radial line. Thus, the transverse bolt 8 and the total length of the side line thereof bears on the respective edge 10, 12.

Again with reference to FIG. 1 illustrating the transverse bolt bearing on the side edge 12 of the stop element 11. Of course, the boundary area facing the transverse bolt is not an edge, but a face adapted to the cross-sectional contour of the transverse bolt 8. Thus, the transverse bolt does indeed not just bear along the bolt longitudinal direction, but also along the peripheral direction on a large area.

The position of the operating element 4 in the illustration of FIG. 1 and FIG. 2 is also shown in the perspective illustration of FIG. 3.

The functioning of the valve represented by the valve cartridge will subsequently be explained with reference to FIG. 4 and FIG. 5. FIG. 4 and FIG. 5 schematically show a plan view of the actual disk control arranged in the cartridge housing 1. Said disk control comprises a fixed distributor disk 13 sitting below the drawing plane and including an outlet opening 14 and two inlet openings, 15 for cold water and 16 for hot water. A rotatable control disk 17 to be rotated by means of the operating element 4, lies on said fixed distributor disk 13. The rotatable control disk 17 has a through hole 18 with a laterally disposed through hole protrusion 18a shaped like an arcuate slot. In FIG. 4, the lateral arcuate slot protrusion 18a of the through hole is oriented so as to match the inlet opening 15 for cold water.

When the movable control disk 17 is rotated clockwise by means of the operating element, the protrusion 18a starts to cover the inlet opening 16 for hot water, whereas at the same time covering of the inlet opening 15 for cold water decreases. Approaching the end of the clockwise movement, the control disk 17 has reached the position shown in FIG. 5, where the protrusion 18a covers not more than the inlet opening 16 for hot water. Further rotation is prevented by the fact that the transverse bolt 8 now abuts the edge 10 of the upper face wall 7 or the stop face belonging to this edge 10.

Due to the removable stop element 11, the valve performs like a mixer valve in the embodiment according to FIG. 1 to FIG. 5.

The removable stop element 11 can be removed from the upper side in FIG. 1, if the operating element is turned to such an extent that the transverse bolt 8 releases the stop element 11.

Once the stop element 11 has been removed, a valve is obtained as shown in the subsequent figures, starting with FIG. 6 corresponding to FIG. 3. Now, the above-mentioned second edge running approximately diametrically to the edge 10 is visible. In the position shown in FIG. 6, the transverse bolt 8 abuts said second edge 20.

FIG. 7 corresponding to FIG. 2 is another illustration thereof, namely of the two approximately diametrically and radially extending edges 10 and 20, similarly slightly offset at the side relative to a diameter, for the above-mentioned reasons. The transverse bolt 8 is turned to a central position by means of the operating element 4. The subsequent discussion is based on the assumption that the position of the operating element 4 is that one shown in FIG. 6, namely the transverse bolt 8 abutting the second boundary edge 20 of the end face wall 7. The respective position of the movable control disk 17 is shown in FIG. 8. The through hole 18 with its protrusion 18a is overlapping not more than the outlet opening 14 of the distributor disk 13, so that only the outlet opening 14 is opened, but both inlet openings 15, 16 are closed.

When the control disk 17 is rotated clockwise by means of the operating element, initially only the inlet opening for cold water is gradually opened, until the latter is completely opened, see FIG. 9. FIG. 9 corresponds to FIG. 4 of the previous embodiment. When the operating element is further turned in the same direction, the same processes occur as described with reference to FIG. 4 and FIG. 5. In this area, the valve behaves just like the valve of the previous embodiment.

Thus, a valve is created and serves to open the cold water and to subsequently mix the water. Said change of character is effected by simply removing the removable stop element 11.

A further option is to attach the removable stop element 11 as illustrated in FIG. 2 not to the right side, so that the rotation of the disk control is prevented in the direction of the closed position, but also to the left side in the vicinity of the stop edge 10 assigned to the hot water position. In this case, the movement of the rotatable control disk 17 would be effected in between the positions shown in FIG. 8 and FIG. 9. Thus, a simple quantity control valve for cold water is provided thereby.

By reducing the peripheral extent of the stop element 11 and arranging said element in front of the edge 10 assigned to the hot water position, a valve may be obtained, wherein in the end position, the inlet opening 16 for hot water is only partially opened and the inlet opening 15 for cold water is only partially closed.

1. A mixer cartridge for a sanitary fitting, including
a cartridge housing,
a disk control arranged in the cartridge housing,
an inlet into the cartridge housing for hot water,
an inlet into the cartridge housing for cold water,
an outlet out of the cartridge housing for mixed water, as well as
an operating element,
controlling the disk control from a closed position through an opened position for cold water only, an opened position for cold and hot water to an opened position for hot water only, wherein
both end positions are determined each by a stop which is fixed to the housing, as well as having
an attachment facility for a removable stop element),
to limit the movement of the operating element on one side.

2. A mixer cartridge according to claim 1, wherein the attachment facility is arranged in such a way that the removable stop element limits the movement of the operating element in a direction to the closed position or restricts said movement, if applicable.

3. A mixer cartridge according to claim 1, wherein the attachment facility is embodied in such a way that the removable stop element limits the movement of the operating element in a direction to the opened position for hot water.

4. A mixer cartridge according to claim 1, wherein the removable stop element can be attached in several angular positions.

5. A mixer cartridge according to claim 1, wherein the removable stop element is pluggable, particularly in axial direction of the cartridge housing.

6. A mixer cartridge according to claim 1, having a transverse bolt arranged on the operating element, designed as a movable element which may come into contact with the stop.

7. A mixer cartridge according to claim 6, wherein at least one stop, particularly the removable stop element, is adapted to the cross-sectional shape of the transverse bolt.

8. A mixer cartridge according to claim 1, wherein an only partially developed cover face of a housing upper part with approximately radially running end portions thereof establishes the stop which is fixed to the housing.

9. A mixer cartridge according to claim 1, wherein the lateral surface area of the housing upper part features a toothing configured so as to fix the removable stop element.
